(19) United States
(12) Patent Application Publication
(10) Pub. No.: US 2025/0328364 A1
(43) Pub. Date: Oct. 23, 2025

(54) GENERATING A SCROLLABLE FEED HAVING ITEMS ARRANGED IN GROUPS

(71) Applicant: Microsoft Technology Licensing, LLC, Redmond, WA (US)

(72) Inventors: Nektarios IOANNIDES, Seattle, WA (US); Utkarsh TYAGI, Vancouver (CA); Kamal GINOTRA, Kirkland, WA (US); Avinash VEMULURU, Sammamish, WA (US); Souvick SARKAR, Redmond, WA (US); Anqi LUO, Redmond, WA (US); Andrew MCNAMARA, Belwood (CA); Sumeet RANKA, Vancouver (CA); Shruthi RAMESH, Issaquah, WA (US)

(21) Appl. No.: 18/644,039

(22) Filed: Apr. 23, 2024

(51) Int. Cl. G06F 9/451; G06F 3/0485; G06F 16/438

(52) U.S. Cl. CPC G06F 9/451; G06F 3/0485; G06F 16/438

(57) ABSTRACT

Technologies related to constructing a scrollable feed of electronic content items are described, where electronic content items in the scrollable feed of electronic content items are arranged in groups in the scrollable feed. Clusters of electronic content items are generated based upon previous user interactions with electronic content items, and representations of the clusters are formed. Based upon a request for a scrollable feed, electronic content items that are of interest to the user are identified and assigned to the clusters based upon the representations of the clusters, thereby forming groups of electronic content items. The scrollable feed is caused to be displayed, where the feed includes the groups.

### BACKGROUND

Computer-executable feed applications are configured to provide a diverse set of electronic content items (such as images, webpages, videos, social media posts, blog posts, etc.) to a user upon receipt of a request from the user for a scrollable feed of content. In an example, a computer-executable feed application provides the user with a scrollable feed of electronic content items, where the electronic content items are identified by the computer-executable feed application as potentially being of interest to the user. The items in the feed are arranged in an order, where the computer-executable feed application utilizes any suitable ranking technologies in connection with determining the order in which the items are to be presented to the user in the feed. Specifically, the computer-executable feed application positions a most highly ranked item in a most prominent position in the feed (e.g., in an upper left-hand corner of the feed), positions a next most highly ranked item in a second most prominent position in the feed (e.g., immediately to the right of the most highly ranked item), and so forth.

It has been empirically observed, however, that users have difficulty parsing items in a feed provided by computer-executable feed applications, particularly when a display upon which the feed is presented is relatively large (e.g., such that multiple items are simultaneously displayed in both horizontal and vertical directions). This difficulty of users in parsing items results in the users having difficulty identifying items of interest in the feed, which in turn results in the users scrolling the feed in order to identify items of interest. When the user scrolls the feed, the client computing device transmits calls to a server computing system for additional items to include in the feed, and the server computing system transmits the additional items to the client computing device, thereby unnecessarily consuming resources of the client computing device, the server computing system, and network bandwidth.

### SUMMARY

The following is a brief summary of subject matter that is described in greater detail herein. This summary is not intended to be limiting as to the scope of the claims.

Described herein are various technologies pertaining to a computer-executable feed application, where the computer-executable feed application presents a scrollable feed of electronic content items (items) to an electronic device associated with a user of the feed application, the scrollable feed includes groups of items, and further where the groups are reflective of interests of the user. In an example, when the computer-executable feed application ascertains that the user has an interest in action films and professional baseball, the feed application generates a scrollable feed that includes a first group of items and a second group of items, where the first group includes items pertaining to action films and the second group includes items pertaining to professional baseball. When a group includes multiple items, each item in the group is caused to be displayed adjacent to (horizontally or vertically) at least one other item in the group; accordingly, each item in the first group is displayed adjacent to at least one other item in the first group. Displaying items in groups in a scrollable feed generated by a feed application has been empirically observed (in internal testing) to be associated with less user scrolling, and therefore less unnecessary consumption of resources of computing devices and network bandwidth, when compared to an amount of user scrolling observed when items in a scrollable feed are displayed in rank order and not grouped by topic.

In connection with generating a scrollable feed of items where items are grouped based upon interests of the user, clusters of items are generated based upon user history data; items are subsequently assigned to the clusters. With more particularity, user history data can identify items previously interacted with by the user (e.g., a search result returned by a search engine that was selected by the user, an image in a scrollable feed selected by the user, a webpage visited by the user, an item saved by the user, etc.), as well as queries issued by the user to a computer-executable application (such as a search engine, a social media application, etc.). The items and queries are clustered into several clusters based upon embeddings of the items and queries, where the embeddings are representations of the items and queries and further where the embeddings are in a shared latent space. Accordingly, numerous clusters are formed that are representative of topics of interest to the user. Representations of the clusters can then be generated. In an example, a representation of a cluster is a centroid of embeddings included in the cluster. The clusters and representations can be generated periodically (e.g., once a day) or immediately in response to receiving a request for a scrollable feed.

When the user requests a scrollable feed of items, the computing device associated with the user receives a request from the user for the scrollable feed of items, and the feed application receives a request for the scrollable feed of items from the computing device. The feed application identifies items that are potentially of interest to the user and ranks such items to form a ranked list of items. The feed application selects items from the ranked list of items based upon the ranking of such items. For example, the feed application selects the N most highly ranked items from the ranked list of items. The selected items are then assigned to the previously generated clusters. More specifically, each item is represented by a respective embedding that shares the latent space with the cluster representations, and items are assigned to clusters based upon the embeddings of the items and the representations of the clusters. Accordingly, groups of items are formed, where a group of items includes items assigned to a cluster. The feed application then constructs a scrollable feed of items and causes such feed of items to be presented on a display of a client computing device of the user, where the feed includes items that are grouped according to the groups.

In an alternative approach, a generative model (e.g., a large language model) can be used together with the feed application in connection with constructing a feed of items, where items in the feed are grouped based upon topics. The user history data can be accessed to identify items previously interacted with by the user and queries submitted by the user. The feed application constructs a prompt, where the prompt identifies: 1) items previously interacted with by the user; 2) queries submitted by the user; and 3) an instruction for the generative model to identify topics that are related to the identified items and queries. Optionally, the prompt includes an instruction for the generative model to rank the topics based upon user interest in the topics. Based upon the prompt, the generative model outputs a list of topics that are related to the items and queries identified in the prompt. Search queries can then be constructed based upon the topics output by the generative model, and such search queries can be independently submitted to a search engine. In an example, a search query comprises a topic output by the generative model, and the search query is submitted to the search engine. The search engine returns a ranked list of items based upon the query; because the search engine returns the ranked list of items based upon the query that comprises the topic, the items in ranked list are germane to the topic and can be included in a group. This process can be repeated for each topic output by the generative model, such that groups of items are output by the search engine. In an example, a top M number of most ranked items identified by the search engine based upon a search query are included in a group, and the group is in a scrollable feed that is caused to be displayed on the client computing device of the user.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic that depicts a scrollable feed of electronic content items (items).

FIG. 2 is a functional block diagram of a system that facilitates construction of a scrollable feed of items, where items in the scrollable feed are arranged in groups.

FIG. 3 is a functional block diagram of a system that facilitates construction of clusters that are representative of interests of a user.

FIG. 4 is a functional block diagram of a system that facilitates generation of a scrollable feed of items, where items in the scrollable feed are arranged in groups.

FIG. 5 is a flow diagram that illustrates a method for causing items to be presented in a scrollable feed of items, where the items in the scrollable feed are arranged in groups.

FIG. 6 is a flow diagram that illustrates a method for creating clusters that are representative of interests of a user.

FIG. 7 is a flow diagram that illustrates a method for causing a scrollable feed to be displayed to a user of a client computing device, where the items in the scrollable feed are arranged in groups.

FIG. 8 is a graphical user interface, where subgroups of items are presented in response to receipt of a user selection of a group of items in a scrollable feed.

FIG. 9 is a graphical user interface of a search engine results page, where search results are arranged in groups that correspond to interests of a user.

FIG. 10 is a graphical user interface of a scrollable feed that includes items arranged in groups, where a group of items includes a hero item and several other items.

FIG. 11 is a graphical user interface of a scrollable feed that includes items arranged in groups, where a group of items includes a hero item and several other items.

FIG. 12 depicts expansion of a group of items in a scrollable feed to include at least one other item upon receipt of a user selection of the group of items.

FIG. 13 depicts removal of a group of items from a scrollable feed in response to receipt of a request from a user to remove the group of items from the feed.

FIG. 14 is a schematic of a computing system

### DETAILED DESCRIPTION

Various technologies pertaining to constructing and causing display of scrollable feeds of items, where items in the scrollable feed are arranged in groups that are representative of user interests, are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. Hence, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “system,” and “module” are intended to encompass computer-readable data storage that is configured with computer-executable instructions that cause certain functionality to be performed when executed by a processor. The computer-executable instructions may include a routine, a function, or the like. It is also to be understood that a component, system, or module may be localized on a single device or distributed across several devices.

Various technologies pertaining to generating a scrollable feed of electronic content items (referred to herein as “items”) are described herein. An item can be an image, a webpage, a social media post, a video, a blog post, or the like. With more particularity, the technologies described herein relate to identifying items and arranging the items in groups in the scrollable feed, where items in a group are topically related to one another. Aspects disclosed herein pertain to creating clusters that are representative of interests of a user, where the clusters are generated based upon previously observed user interactions with electronic content items and/or previous queries submitted by the user to a search engine, a social media application, or the like. When items that have yet to be seen by the user are identified as being of interest to the user (and therefore to be included in a feed), such items are assigned to the previously created clusters, thereby creating groups of items. The scrollable feed is then constructed, where the scrollable feed includes the groups of items (such that items belonging in a same group are displayed next to one another). It has experimentally been observed that displaying items in groups in scrollable feeds reduces scrolling by users through the feeds when compared to scrolling by users through feeds with items arranged in rank order, which in turn reduces calls made from client computing devices to server computing devices that deliver the feeds to the client computing device (and accordingly reduces bandwidth consumption) when compared to feeds with items arranged in rank order.

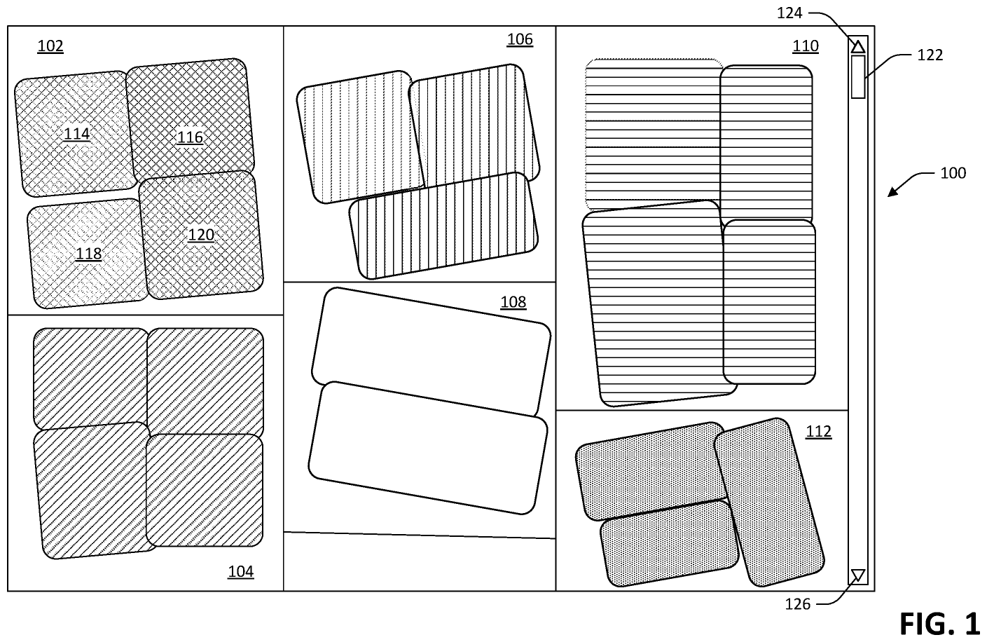

With reference now to FIG. 1, a graphical user interface 100 of a scrollable feed is illustrated, where the scrollable feed includes items that are arranged in groups. The scrollable feed includes groups 102-112, where each of the groups 102-112 is depicted as including multiple items. As noted above, the items included in the feed can be images, graphical representations of webpages, videos, posts (such as social media posts, blog posts, etc.).

The groups 102-112 represent topics that are of interest to the user. Thus, items in a same group are topically related to one another. For example, the first group 102 of items is depicted as including four items 114-120, and each of the items 114-120 is identified as being potentially of interest to the user and topically related to other of the items 114-120. In an example, the user previously expressed interest in action movies, and the items 114-120 belong to the topic “action movies”. In a more specific example, the items 114-120 are images of posters of action movies.

A scroll bar 122 and scroll arrows 124 and 126 are selectable and employable by the user to scroll the scrollable feed. For example, the user can select the scroll bar 122 (through use of a mouse pointer, touch, etc.) and move the scroll bar 122 downward, thereby scrolling the scrollable feed. As the user scrolls the scrollable feed, items (such as items in the groups 102, 106, and 110) exit a viewable region while new items (arranged in groups) enter the viewable region.

Groups of items can be delineated from one another in any suitable manner. For example, the first group 102 of items has a first color assigned thereto while the second group 104 of items has a second color assigned thereto that differs from the first color. For instance, the first group 102 of items is displayed over a light green background while the second group 104 of items is displayed over a light blue background. In another example, items in a group are stacked (such that items are able to overlap with one another) to preserve aspect ratios of each item in a group. In another example, respective aspect ratios of items are modified to allow for items to be shown more uniformly within a group (so that vertical and horizontal edges of an item in a group are aligned with at least one vertical or horizontal edge of another item in the group).

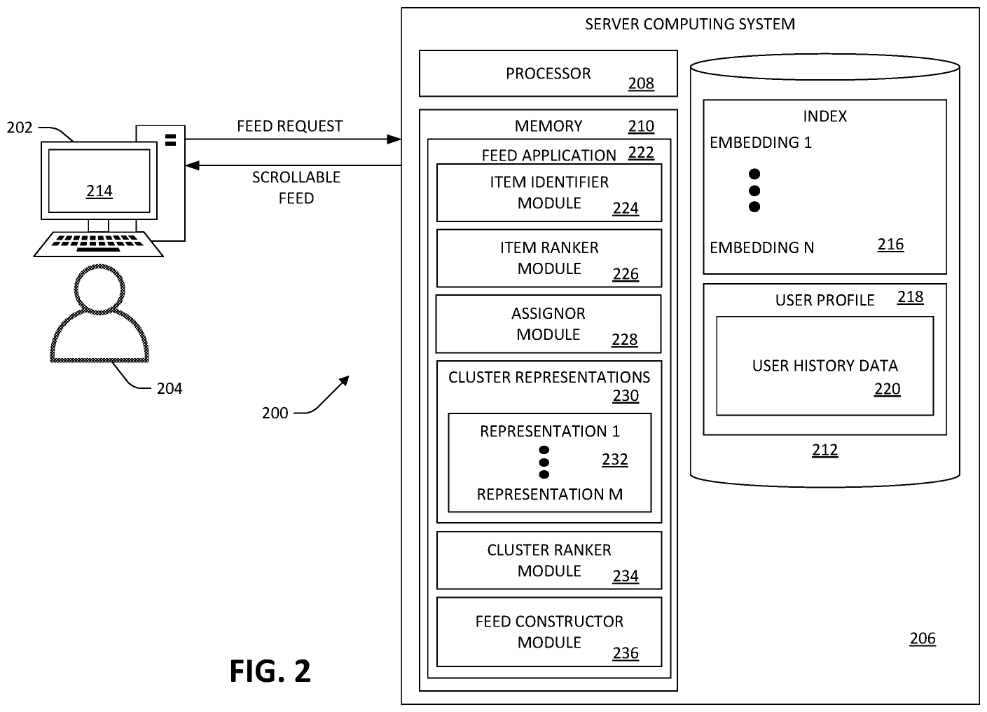

Now referring to FIG. 2, a system 200 that is figured to cause a scrollable feed of items to be presented on a display of a client computing device operated by a user is illustrated. The system 200 includes a client computing device 202 operated by a user 204. The client computing device 202 can be a desktop computing device, a laptop computing device, a tablet computing device, a smart television, a smart projector, etc. The system 200 also comprises a server computing system 206 that is in communication with the client computing device 202 by way of a network connection. The server computing system 206 includes a processor 208 and memory 210 that stores instructions that are executed by the processor 208. The server computing system 206 also comprises a data store 212 that includes data that can be retrieved by the processor 208. The client computing device 202 comprises or is associated with a display 214, where a scrollable feed of items can be presented to the user 204 on the display 214 (such as the scrollable feed shown in FIG. 1).

The data store 212 of the server computing system 206 stores an index 216 of embeddings of items (e.g., N embeddings for N items). The embeddings are vector representations of the items, where the embeddings are in a shared latent space. For example, each embedding is a 64K vector of numerical values that represent a respective item. Any suitable embedding technologies can be employed in connection with generating the embeddings. For instance, when the items are textual, an embedding algorithm such as Word2Vec can be employed to generate embeddings. In another example, a machine learning algorithm is trained to generate the embeddings. Hence, an image can be provided to the machine learning algorithm, and the machine learning algorithm outputs a vector that represents the image.

The data store 212 also includes a user profile 218 that comprises user history data 220. The user history data 220 identifies interactions of the user 204 with respect to items represented by embeddings in the index 216. In addition, the user history data 220 can include representations of queries set forth by the user 204 to a search engine, queries set forth by the user 204 to a social media application, queries set forth by the user 204 to an electronic commerce application, queries set forth by the user 204 to a computer-executable feed application, queries set forth by the user 204 to productivity applications (a word processing application, a spreadsheet application, a slideshow application, and e-mail application, and so forth), and the like. Moreover, the user history data 220 can include information that is indicative of explicit or implicit feedback of the user 204 with respect to items represented by the embeddings in the index 216. For example, the user history 220 data can include data that indicates that the user 204 “liked” or “disliked” an item, that indicates that the user 204 clicked on an item when the item was included in a set of search results, that indicates that the user 204 scrolled past an item shown in a scrollable feed without hovering over or otherwise interacting with the item, and so forth. With respect to queries issued by the user 204, the user history data 220 can include embeddings of the queries that are in the same latent space as the embeddings in the index 216.

The memory 210 includes a feed application 222 that is configured to construct scrollable feeds of items for display on the display 214 of the client computing device 202. The client computing device 202 includes a suitable application that can be used to access the feed application 222. For instance, the client computing device 202 has a web browser installed thereon that can be employed to access the feed application 222. In another example, the client computing device 202 includes a standalone application that is usable to access the feed application 222.

The feed application 222 includes an item identifier module 224 that is configured to identify items that are of potential interest to the user 204, where such items are represented by embeddings in the index 216. The item identifier module 224 identifies such items based upon the user history data 220. In a nonlimiting example, the user history data 220 indicates that the user 204 previously selected an image represented by an embedding in the index 216, where the image is a poster of an action movie. The item identifier module 224 can retrieve the user history data 220 and ascertain, based upon the user history data 220, that the user previously selected such image. The item identifier module 224 can identify other images that are similar to the image previously selected by the user 204; for instance, the item identifier module 224 can employ a nearest neighbor table to identify other images represented by embeddings in the index 216 that are similar to the image previously selected by the user 204 (e.g., where the identified images can be other images related to the action movie or a different action movie). In another example, the item identifier module 224 can search the index 216 based upon queries previously submitted by the user, where such queries (or representations thereof) are included in the user history data 220.

The feed application 222 also includes an item ranker module 226 that ranks items identified as being potentially of interest to the user 204 by the item identifier module 224. The item ranker module 226, in an example, ranks the items identified by the item identifier module 224 based upon the user history data 220. As indicated previously, the user history data 220 can include data that is indicative of interactions of the user 204 with respect to items represented by the embeddings in the index 216. The item ranker module 226 can rank items identified by the item identifier module 224 based upon whether the user “liked” an item that is similar to an item identified by the item identifier module 224, whether the user “disliked” an item that is similar to an item identified by the item identifier module 224, whether the user 204 scrolled past an item in a feed, whether the user 204 dwelled on an item when the item was displayed to the user 204, etc. The item ranker module 226 can additionally or alternatively employ signals pertaining to a group of users when ranking items. For example, if a relatively large number of users interacted with an item, then the item ranker module 226 assigns a relatively high-ranking to such item. Accordingly, the item ranker module 226 can output a ranked list of items (where items in the ranked list of items have not previously been provided to the user 204 in a feed and/or have not been provided to the user 204 in the feed for some threshold amount of time, such as a week).

The memory 210 further includes an assignor module 228 and cluster representations 230, where the cluster representations 230 include several representations 232 of clusters of items. As will be described in greater detail below, clusters of items can be constructed, where each cluster is representative of an interest of the user 204, and further where the clusters are constructed based upon the user history data 220. The representations 232 can be in the same latent space as the embeddings in the index 216. Therefore, in an example, each of the representations 232 is a 64K vector.

The assignor module 228 selects items from the ranked list of items output by the item ranker module 226 and assigns the selected items to clusters based upon the embeddings of the items in the index 216 and the representations 232 of the clusters. For example, the assignor module 228 computes cosine similarity scores between an item selected by the assignor module 228 and each cluster representation in the cluster representations 232. The assignor module 228 assigns the item to a cluster that is represented by the cluster representation that is closest (based on the cosine similarity scores) to the item. Effectively, then, the assignor module 228 creates several groups of items, where items included in a same group are thematically related to one another.

The feed application 222 also includes a cluster ranker module 234 that is configured to rank clusters that have items assigned thereto by the assignor module 228. The cluster ranker module 234 can rank the clusters based upon the user history data 220. For example, the user history data 220 can indicate that the user 204 frequently interacts with items assigned to a specific cluster (e.g., frequently “likes” items assigned to a cluster when such items are presented to the user 104). The cluster ranker module 234 can then rank such cluster more highly than other clusters that do not have items assigned thereto that have frequently been interacted with by the user 204. In addition, items selected by the assignor module 228 that are assigned to a cluster can be ranked relative to one another within the cluster based upon the ranking of the items performed by the item ranker module 226. Thus, each item selected by the assigner module 228 can have two identifiers assigned thereto: 1) a first identifier that identifies a cluster to which the item has been assigned; and 2) a second identifier that identifies a rank of the electronic content item within the cluster.

The feed application 222 further includes a feed constructor module 236 that is configured to construct a scrollable feed for display on the display 214 of the client computing device 202. The feed constructor module 236 constructs the scrollable feed such that items are presented in groups in the scrollable feed, such as depicted in FIG. 1. In the scrollable feed, when a group includes multiple items, each item in the group is displayed adjacent to (either horizontally or vertically) at least one other item included in the group.

Operation of the computing system 200 is now described. The client computing device 202 receives a request from the user 204 for a scrollable feed, and the client computing device 202 transmits a request for the scrollable feed to the server computing system 206. The feed application 222 receives the request, and the item identifier module 224 identifies items represented by embeddings in the index 216 that are potentially of interest to the user 204. As described above, the item identifier module 224 identifies the items that are potentially of interest to the user 204 based upon the user history data 220. The item ranker module 226 ranks the items identified by the item identifier module 224 (e.g., based upon the user history data 220). The assignor module 228 selects items based upon the ranking of the items performed by the item ranker module 226 and assigns the selected items to clusters based upon embeddings of the items and the cluster representations 232. The cluster ranker module 234 ranks the clusters based upon the user history data 220 and the feed constructor module 236 constructs the scrollable feed based upon the ranking of the clusters and the items assigned to the clusters. The feed constructor module 236 causes the server computing system 206 to transmit the scrollable feed to the client computing device 202, whereupon the client computing device 202 displays the scrollable feed to the user 204. The process repeats as the client computing device 202 receives additional requests for items in a scrollable feed from the user 204. For example, as the client computing device 202 receives an indication that the user 204 is scrolling the scrollable feed, the client computing device 202 can transmit a new feed request to the server computing system 206, and the above-described process repeats.

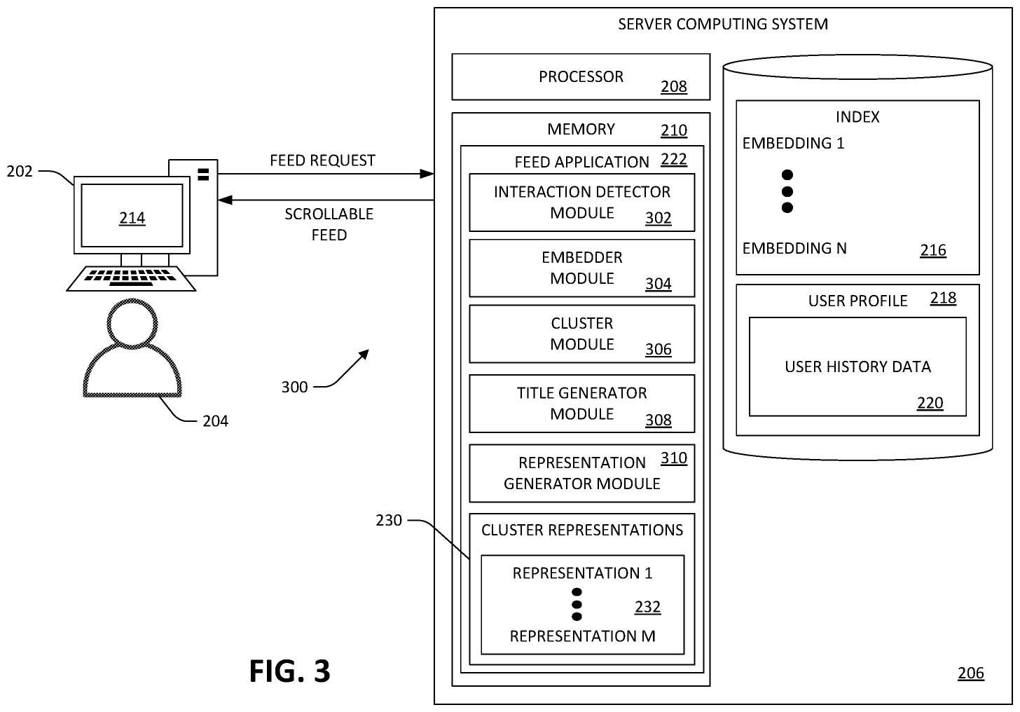

Turning now to FIG. 3, a system 300 that is configured to construct the cluster representations 230 is illustrated. While the system 300 is illustrated as being separate from the system 200, in an example, the server computing system 206 shown in FIG. 2 includes the modules described with respect to FIG. 3 as well as the modules described with respect to FIG. 2. The system 300 includes the client computing device 202 and the server computing system 206. The memory 210 includes the feed application 222, which includes an interaction detector module 302 that detects interactions of the user with respect to items and updates the user history data 220 based upon the detected interactions. For example, the interaction detector module 302 detects that the user 204 has selected a search result presented on a search engine results page by a search engine and updates the user history data 220 to indicate that the search result (which may be a webpage, an image, a video, etc.) has been selected by the user 204. In another example, the interaction detector module 302 detects that the user has “disliked” a blog post, and the interaction detector module 302 updates the user history data 220 to indicate that the user 204 disliked the blog post. In yet another example, the interaction detector module 302 can ascertain that the user 204 has set forth a query to a search engine, a social media application, or the like, and updates the user history data 220 to indicate that the user 204 set forth the query to the search engine, social media application, etc.

The memory 210 further includes an embedder module 304 that creates embeddings for items, for queries set forth by the user, and so forth. In an example, a search engine may maintain an index of items. The embedder module 304 creates embeddings for items that are indexed in such index. Output of the embedder module 304 is stored in the index 216. In an example, the embeddings in the index 216 are semantic representations of the items.

The memory 210 further includes a cluster module 306 that creates clusters of items by clustering embeddings of items that have been interacted with by the user 204 and the queries set forth by the user 204. The cluster module 306 can employ any suitable technology for generating the clusters; for instance, the cluster module 306 uses a K-means clustering algorithm to generate the clusters. For instance, over a window of time, the user 204 may have interacted with 100 different items, where the index 216 includes embeddings of those 100 different items. Interaction of the user 204 with the items indicates that the user 204 has some interest in the topics pertaining to the 100 items. The cluster module 306 creates clusters of the embeddings of the items that have been interacted with by the user 204 and embeddings of the queries set forth by the user. Output of the cluster module 306 is several clusters, where a cluster in the several clusters can include items interacted with by the user 204 and queries previously set forth by the user 204 to a search engine and/or social media application.

The memory 210 also optionally includes a title generator module 308 that generates titles for the clusters output by the cluster module 306. There are numerous potential techniques for constructing titles of clusters. In an example, items included in a cluster can be ranked relative to one another (e.g., based upon the user history data 220) and a title of the most highly ranked item in the cluster can be used as the title of the cluster. In another example, natural language processing (NLP) techniques are employed to parse titles and metadata of items in a cluster in connection with constructing a title for the cluster. In still yet another example, a prompt is provided to a generative model, where the prompt comprises: 1) the items included in a cluster; and 2) a request for the generative model to output a title that is descriptive of the items. Based upon the prompt, the generative model can output the title. Other approaches are contemplated.

The memory 210 also includes a representation generator module 310 that generates representations for the clusters output by the cluster module 306, such that each output cluster has a representation generated therefor. As indicated above, the clusters include embeddings from the index 216 and optionally embeddings of queries that are in the same latent space as the embeddings of the index. For instance, to generate a representation of a cluster, the representation generator module 310 can compute a centroid of the representations in the cluster, where the centroid is a representation of the cluster. In another example, the representation generator module 310 computes average values for the embeddings in a cluster, and the cluster representation is a vector that includes the average values. The output of the representation generator module 310 is the cluster representations 230, including representations of M clusters output by the cluster module 306.

As described above, the cluster representations 230 can be used to create groups of items that are topically related to one another, such that a scrollable feed of items can include items that are grouped together, such as shown with respect to the scrollable feed depicted in FIG. 1.

In an example, the cluster module 306 accesses the user history data 220 and creates clusters periodically (e.g., offline). Therefore, when the feed application 222 receives a request for a scrollable feed, the cluster representations 230 are already generated. In another example, the cluster module 306 operates online such that the cluster module 306 constructs the clusters in response to the feed application 222 receiving a request for the scrollable feed from the client computing device 202.

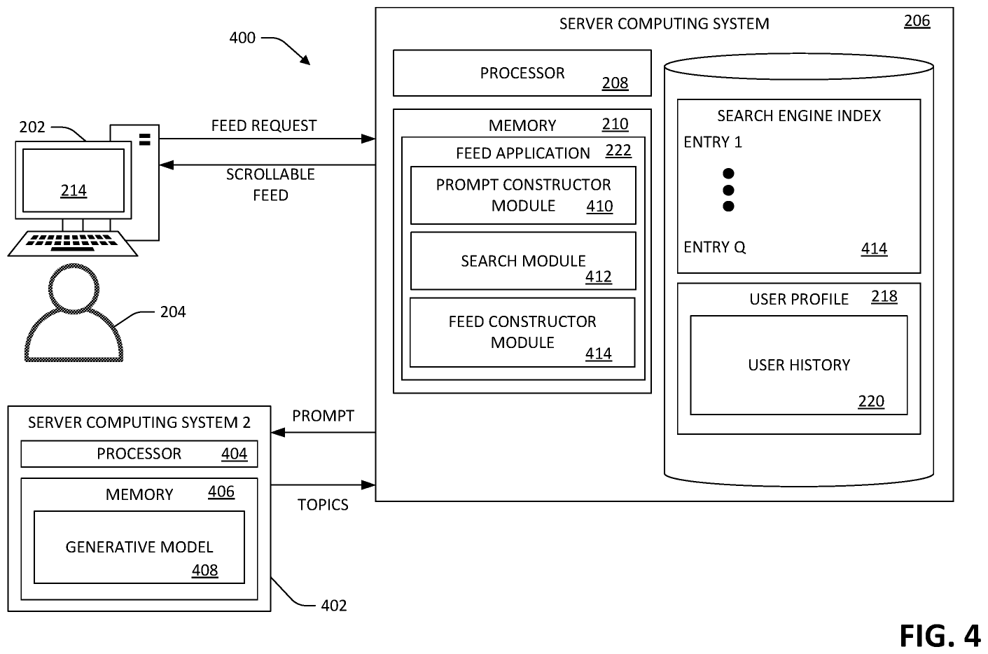

Now referring to FIG. 4, another computing system 400 that is configured to construct a scrollable feed of items is illustrated, where the scrollable feed includes groups of items, and further where items in a group are topically related to one another. The system 400 includes the client computing device 202 operated by the user 204 and the server computing system 206. The system 400 also includes a second server computing system 402 that includes a processor 404 and memory 406. The memory includes a generative model 408, where the generative model 408 is executed by the processor 404. The generative model 408 can be a large language model, an image generator, or any other suitable generative model. While the generative model 408 is illustrated as being executed by the processor 404 in the second server computing system 402, in another example the generative model 408 can be included in the memory 210 of the server computing system 206.

In the example depicted in FIG. 4, the feed application 222 includes a prompt constructor module 402 that constructs a prompt in response to receiving a request for a scrollable feed from the client computing device 202. The prompt constructor module 402 constructs the prompt based upon the user history data 220. In an example, the prompt constructor module 402 identifies items that have previously been interacted with by the user 204 and includes the identified items (or representations thereof) in the prompt. Further, in an example, the prompt constructor module 402 includes queries previously set forth by the user to computer-executable application(s) in the prompt. The prompt can also include a request for the generative model 408 to output a list of topics that pertain to the items and queries included in the prompt. The generative model 408 receives the prompt and outputs a set of topics based upon the prompt.

The second server computing system 402 transmits the topics to the server computing system 206, whereupon the topics are provided to a search module 412. The search module 412 performs several searches based upon the topics output by the generative model 408. In an example, the generative model 408 outputs a topic “action movies”, and the search module 412 searches over a search engine index 414 and returns a set of search results based upon the search (where the search results pertain to the topic “action movies”). The search module 412 can search over a webpage index, an image index, a video index, or other suitable index maintained by a search engine. In addition, the search module 412 ranks the items identified by the search engine as pertaining to the topic “action movies.” The search module 412 can employ a ranking module that is native to the search engine and/or can rank the identified items based upon the user history data 220.

The search module 412 may then select a subset of the identified items based upon the ranking of the identified items and can include subset in a group. Further, the search module 412 can assign the topic output by the generative model 408 as a title for the group (e.g., “action movies”). As the search module 412 performs these operations for each topic output by the generative model 408, the search module 412 creates several groups of items, where each group includes items that are topically related to one another. In an example, the prompt provided to the generative model 408 can also request that the generative model 408 rank the topics (e.g., where the generative model ranks the topics based upon probabilities that the topics are of interest of the user 204).

The feed constructor module 236 then constructs the scrollable feed based upon the groups of items output by the search module 412 and the ranking of the topics output by the generative model 408. That is, the feed constructor module 236 produces a scrollable feed, such as the scrollable feed shown in FIG. 1. The feed constructor module 236 then causes the scrollable feed to be transmitted to the client computing device 202 of the user 204, whereupon the scrollable feed is displayed on the display of the client computing device 202.

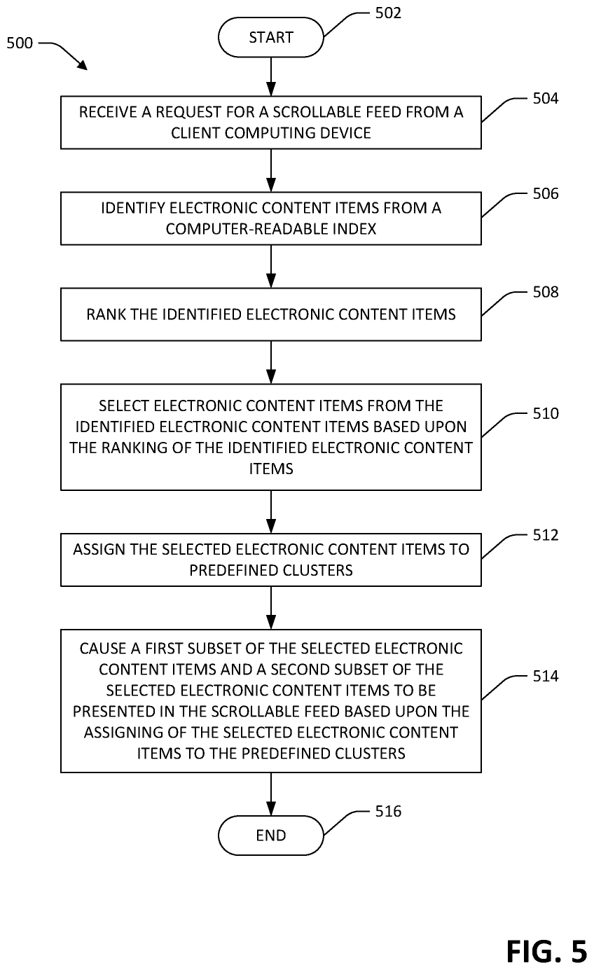

FIGS. 5-7 illustrate methodologies relating to constructing scrollable feeds of items. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 5, a flow diagram illustrating a method 500 for causing a scrollable feed of items to be displayed to a user of a client computing device is illustrated. In an example, the method 500 is performed by the server computing system 206 when executing the feed application 222. The method 500 starts at 502, and at 504 a request for a scrollable feed of items is received from a client computing device operated by a user. The request may be a refresh of a browser, opening of an application where a scrollable feed is displayed, directing a browser to a particular website that is configured to provide a scrollable feed, and so forth.

At 506, items are identified from a computer-readable index based upon the request. The items are identified as being relevant to interests of a user of the client computing device.

At 508, the identified items (the items identified at 506) are ranked based upon values of attributes that correspond to the identified e items. Such attributes may be whether the user has “liked” similar items, a number of users who have interacted with the item, or other suitable attributes.

At 510, a set of items is selected from the identified items based upon the ranking of the identified items performed at 508. In an example, at 510 a top P most highly ranked items are selected.

At 512, the selected items are assigned to predefined clusters of items. Specifically, a first subset of the selected items is assigned to a first cluster and a second subset of the selected items is assigned to a second cluster. In an even more specific example, the first cluster is representative of the topic “action movies” while the second cluster is representative of the topic “professional baseball”.

At 514, a first subset of the selected items and the second subset of the selected items are caused to be presented in a scrollable feed of items based upon the assigning of the selected electronic content items to the predefined clusters. Therefore, in the scrollable feed of items, items that are topically related to one another are shown as being grouped together. The method 500 completes at 516.

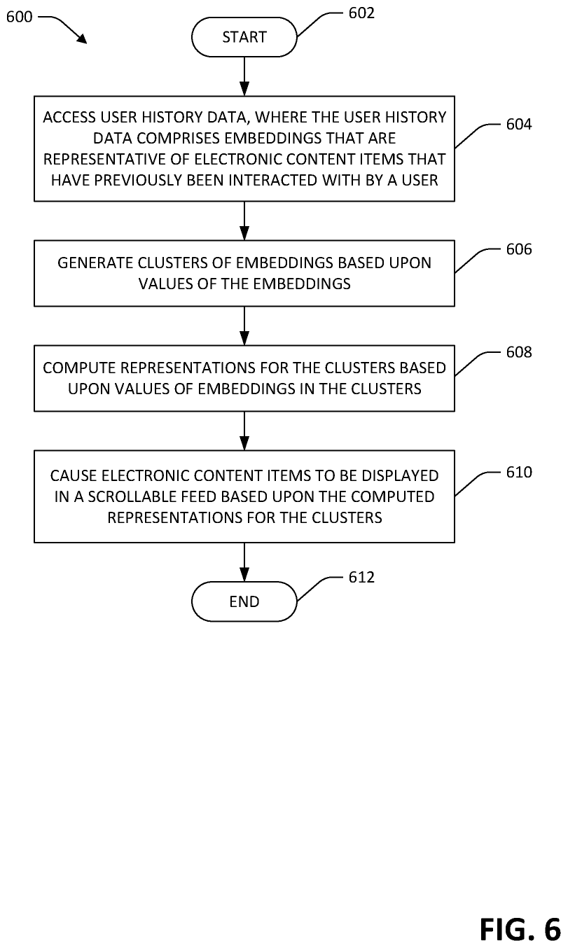

Referring now to FIG. 6, a flow diagram illustrating a method 600 for creating clusters of items in connection with constructing a scrollable feed of items is illustrated. The method 600 starts at 602, and at 604 user history data is accessed, where the user history data identifies items previously interacted with by the user (e.g., previously selected by the user, previously saved by the user previously hovered over by the user, etc.), queries previously set forth by the user, and so forth.

At 606, clusters of items are generated based upon the user history data. With more specificity, the queries and items interacted with by the user can be associated with embeddings that represent such queries and items, where the embeddings are in a same latent space. The embeddings can be clustered based upon values of the embeddings, thereby clustering the items and queries. These clusters are representative of different interests of the user.

At 608, representations for the clusters are generated based upon the values of the embeddings in the clusters. As noted above, a cluster of embeddings can be represented by a centroid of the embeddings.

At 610, items are caused to be displayed in a scrollable feed based upon the computed representations for the clusters. As described above, items can be assigned to the clusters after the clusters have been formed, thereby allowing for groups of items to be created. The scrollable feed of items is then displayed based upon the groups of the items. The method 600 completes at 612.

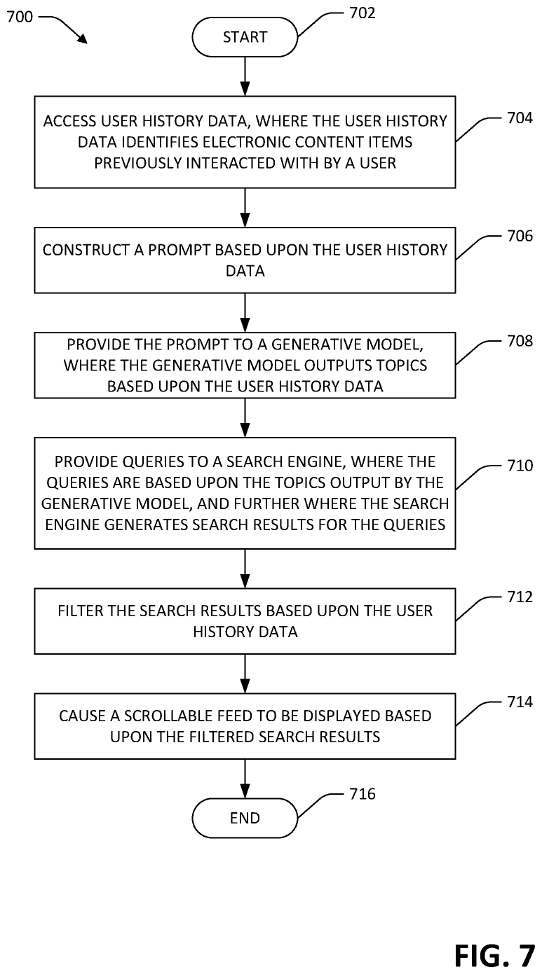

Now referring to FIG. 7, a flow diagram illustrating a method 700 for causing a scrollable feed of items to be displayed on a display of a client computing device is illustrated. The method 700 starts at 702, and at 704 user history data is accessed, where the user history data identifies items previously interacted with by a user (amongst other information). At 706, a prompt is constructed based upon the user history data. The prompt includes items previously interacted with by the user, queries previously set forth by the user to computer-executable applications, etc. The prompt also includes a request for a generative model to output a list of topics that pertain to the items. The prompt also optionally includes a request for the generative model to rank the aforementioned topics.

At 708, the prompt is provided to a generative model, where the generative model outputs topics based upon the user history data. At 710, queries are provided to a search engine, where the queries are based upon the topics output by the generative model, and further where the search engine generates search results for the queries. In an example, when the generative model outputs 10 topics, the search engine performs 10 different searches and outputs 10 different sets of search results, where the search results include ranked lists of items.

At 712, the search results are filtered based upon the user history data. For instance, items with which the user has previously interacted are filtered from the search results. At 714, a scrollable feed of items is caused to be displayed based upon the filtered search results. More specifically, search results that are based upon a first query are displayed as a first group in the scrollable feed while second search results that are based upon a second query are displayed as a second group in the scrollable feed. The method 700 completes at 716.

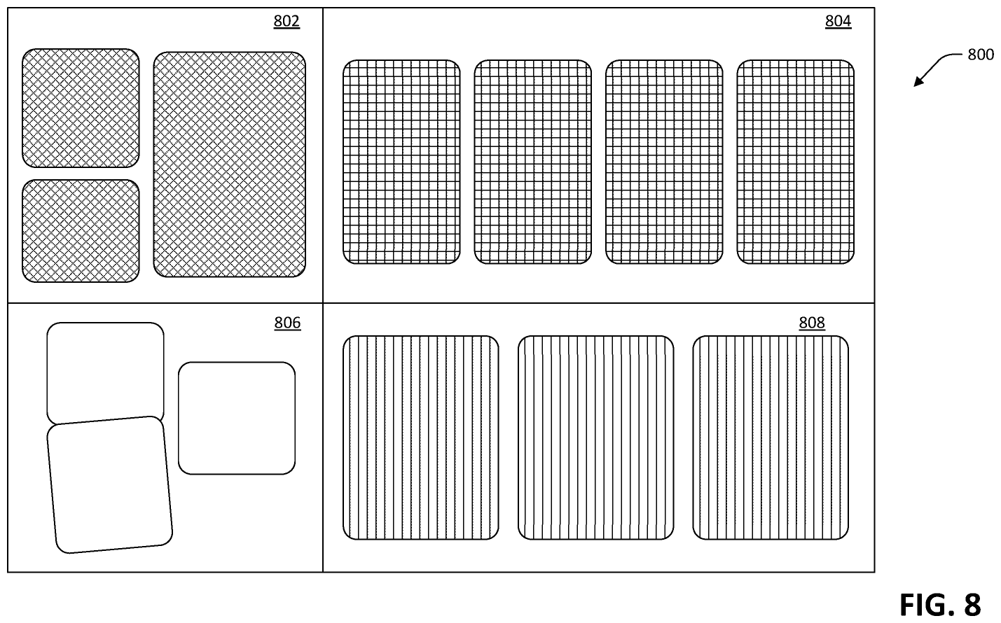

Referring now to FIG. 8, a graphical user interface 800 that depicts subgroups of items that can be displayed upon user selection of a group of items in a scrollable feed is illustrated. Pursuant to an example, the user 204 can select the second group 104 of items in the scrollable feed presented in FIG. 1. In an example, based upon the selection of the second group 104 of items, numerous subgroups 802-808 are displayed, with each of the subgroups including at least one item that pertains to a subtopic of the topic of the parent group (the second group 104). For instance, the second group 104 of the scrollable feed can pertain to a topic of “professional baseball”. Upon the user 204 selecting the second group 104, the subgroups 802-808 are displayed, where, in an example, each subgroup corresponds to a different professional baseball team (e.g., a subtopic of the topic “professional baseball”).

The subclusters of a cluster upon which the second group 104 is based can be generated through use of various technologies. In an example, a prompt can be constructed that includes items shown in the second group 104 and/or items included in the cluster, as well as a request to identify numerous topics that pertain to such items. The prompt is provided to a generative model, which outputs a set of topics (which are subtopics of the parent topic). The topics are provided to a search engine, and the search engine generates search results for each topic in the topics. Hence, subgroups of the groups can be created as the user interacts with groups in the scrollable feed.

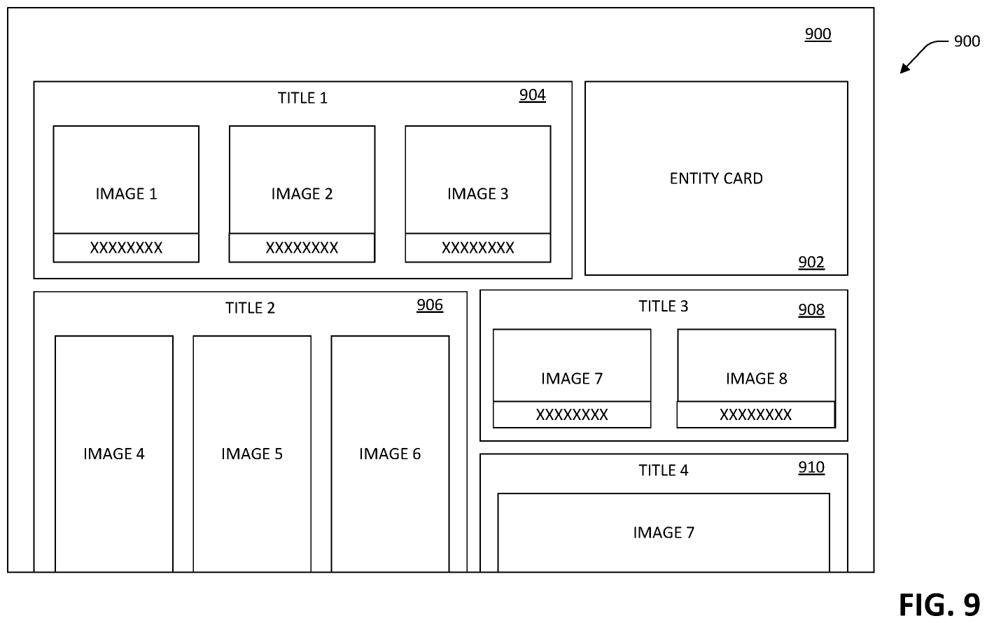

Regarding FIG. 9, a graphical user interface 900 of a search engine results page is depicted. The graphical user interface 900 is set forth to illustrate that technologies described herein can also be employed when displaying search results on a search engine results page (rather than or in addition to presenting items in a scrollable feed). The search engine results page 900 includes an entity card 902 that includes information about an entity that pertains to a query set forth by the user 204. The search engine results page 900 also includes several groups 904-910 of search results, where each group of search results includes search results that are topically related to one another. The groups of search results can be created in a manner similar to how the groups of items were described as being created when constructing a scrollable feed. For example, clusters of items can be created based upon the user history data 220. When the user issues a query, the search engine can identify search results, and the identified search results can be assigned to the clusters. Based upon the ranking of the clusters (as well as ranking of items within the clusters), the search engine results page 900 can be generated. This approach differs from conventional search engine operation, where search results are presented in rank order without grouping search results by topic.

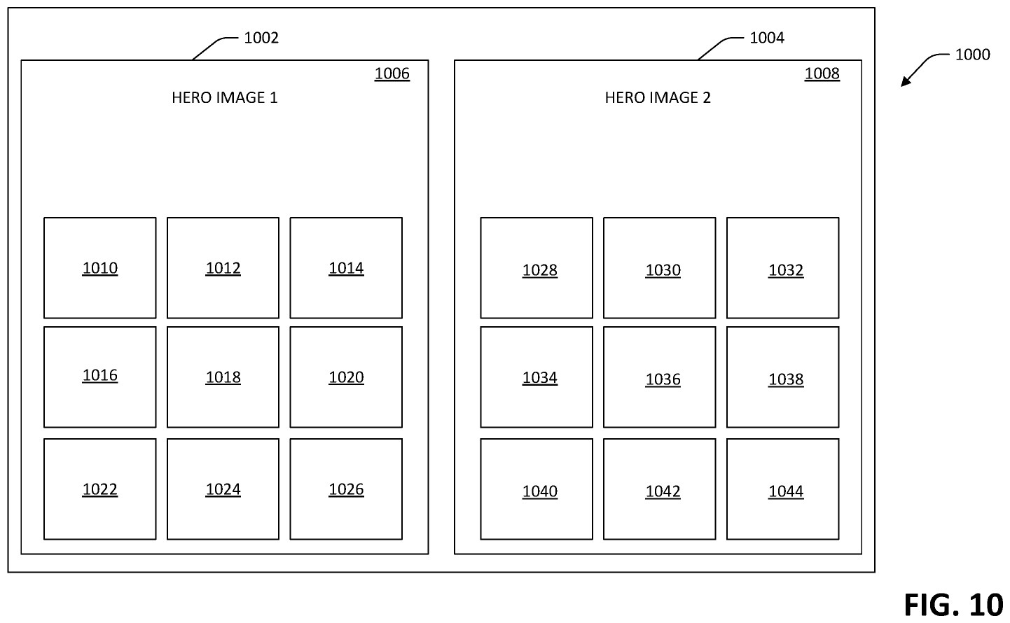

Now turning to FIG. 10, a graphical user interface 1000 that depicts groups of items displayed in a portion of a scrollable feed is depicted. The graphical user interface 1000 depicts two groups of items 1002 and 1004, respectively. Each of the groups of items 1002 and 1004 is shown as including ten items. The items include a hero image 1006 for the first group 1002 and a hero image 1008 for the second group 1004. The hero images 1006 and 1008 may be the most highly ranked images in the groups of images 1002 and 1004, respectively. The hero images 1006 and 1008 are displayed larger than other images in the groups 1004 and 1008.

With more specificity, the first group 1002 items includes the first hero image 1006 and several other images 1010-1026 that are related to the same topic or theme as the first hero image 1006. Similarly, the second group 1008 includes the second hero image 1008 and several other images 1028-1044 that are related to the same topic or theme as the second hero image 1008. As illustrated in FIG. 10, the first hero image 1006 can be extended such that it appears that the images 1010-1026 overlay portions of the first hero image 1006. In an example, the first hero image 1006 is extended such that a color or pattern appears behind the images 1010-1026 that corresponds to the first hero image 1006 but in actuality is not part of the first hero image 1006. Likewise, the second hero image 1008 is extended such that a color or pattern appears behind the images 1028-1044 that corresponds to the second hero image 1008; thus, the groups 1006 and 1008 are visually distinguished from one another.

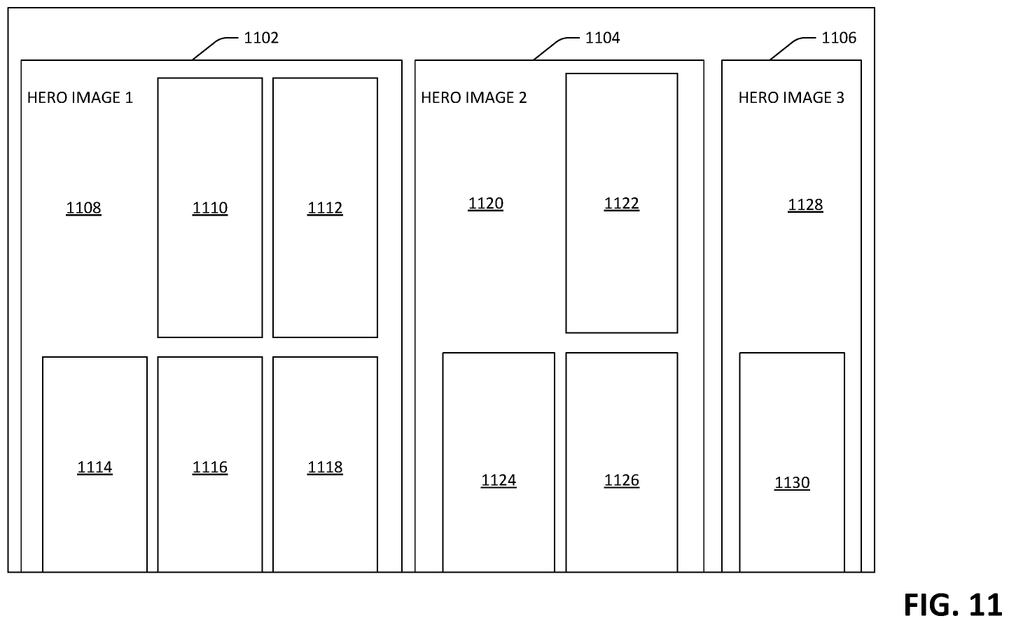

FIG. 11 illustrates another example graphical user interface 1100, where hero images are included in groups of items. The graphical user interface 1100 is similar to the graphical user interface 1000, except that the hero images are displayed beside, in some examples, at least one other image. With more specificity, the graphical user interface 1100 includes groups 1102-1106. The first group 1102 includes a first hero image 1108 as well as images 1110-1118. The first hero image 1108 is extended vertically downward and to the right, such that it appears that the first hero image 1108 acts as a background to the images 1110-1118. The second group 1104 includes a second hero image 1120 and images 1122-1126 that are presented as being overlaid on portions of the second hero image 1120. Similar to the first hero image 1108, the second hero image 1120 can be extended to the right and downward to provide a unifying background for the images 1122-1126. Finally, the third group 1106 includes a third hero image 1128 and an image 1130 that is placed on the third hero image 1128. In the example shown in FIG. 11, the third hero image 1128 is extended downward (but not to the right).

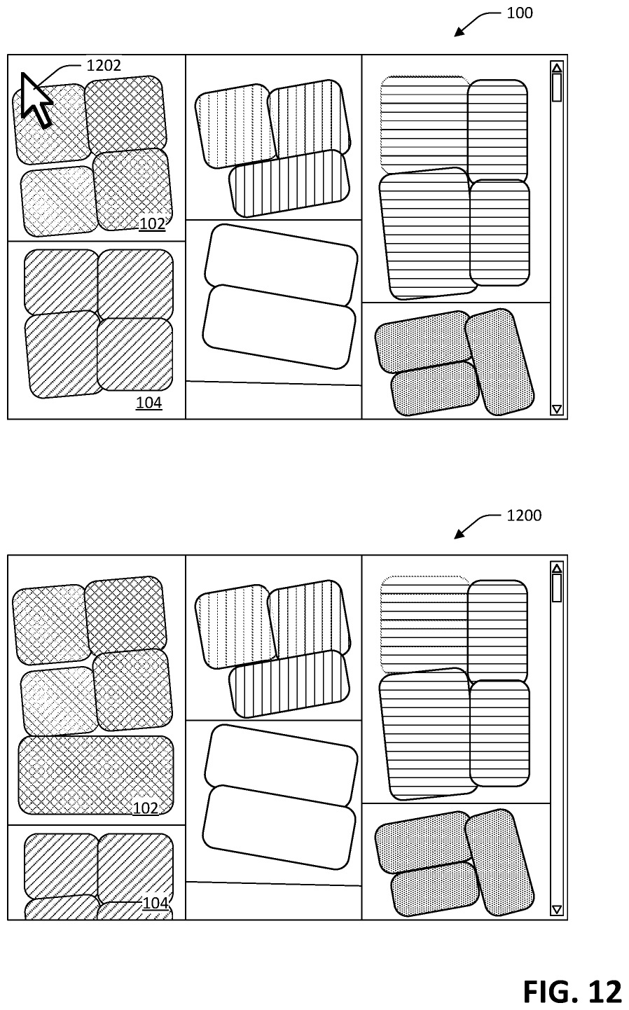

FIG. 12 depicts a sequence of graphical user interfaces, where the sequence includes the graphical user interface 100 and a graphical user interface 1200 that appears in response to user interaction with the scrollable feed shown in the graphical user interface 100. The user 204 employs a pointer 1202 to set forth an indication that the user 204 “likes” the first group 102 of items. Put differently, the user 204 sets forth an indication that the first group 102 is to be expanded. As illustrated in the graphical user interface 1200, the first group 102 is expanded to increase the number of items shown in the first group 102. Further, the feed application 222 receives the indication that the user 204 has liked the first group 102, which can improve ranking of the cluster (upon which the first group 102 is based) when the clusters are ranked. As shown in the graphical user interface 1200, the second group 104 is moved vertically downward to make room for the additional items shown in the first group 102. Therefore, the groups are shown in a waterfall type layout, with groups of items arranged in columns (but not rows).

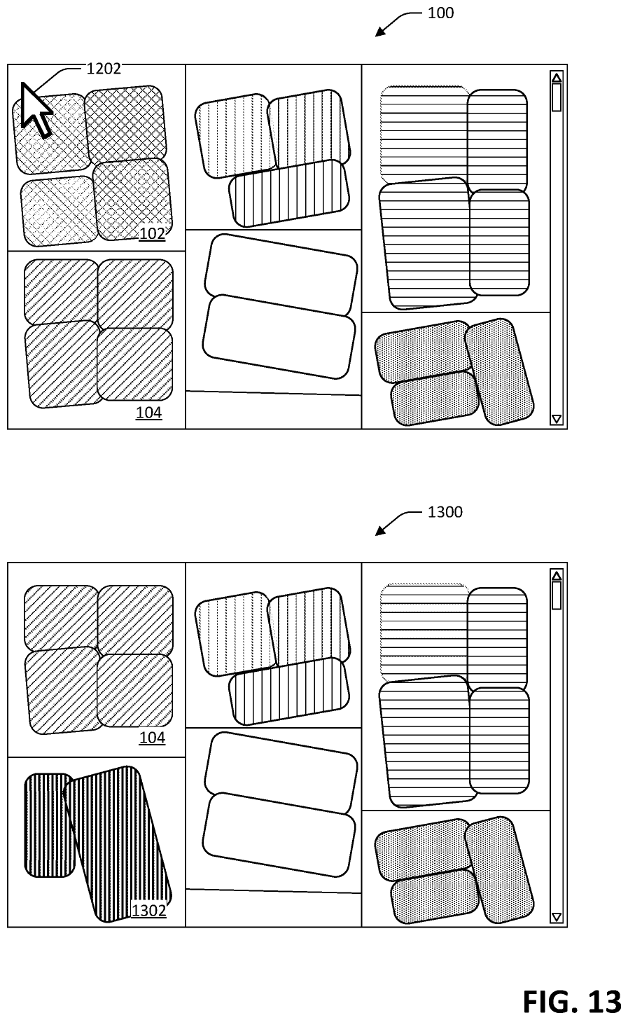

FIG. 13 depicts related graphical user interfaces; specifically, FIG. 13 shows a sequence of graphical user interfaces, where the sequence includes the graphical user interface 100 and a graphical user interface 1300 that is displayed upon a request from the user 204 being received to close or hide a group of items in a scrollable feed. As shown in the graphical user interface 100, the user 204 employs the pointer 1202 to indicate that the first group 102 of items is to be closed (or hidden). Upon the first group 102 being closed, the second group 104 is moved upwards in a column that included the first group 102 and the second group (104), while a new group 1302 is also moved upward in a viewable region of the scrollable feed.

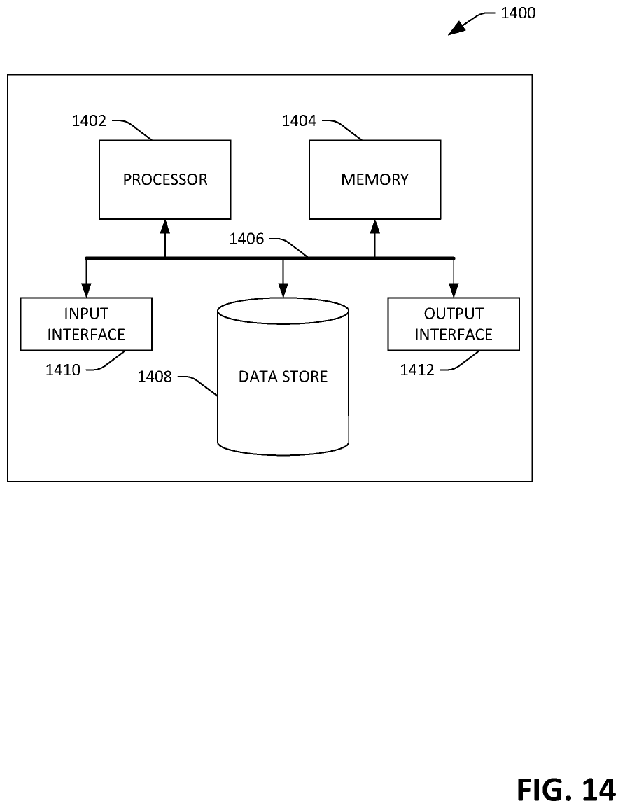

Referring now to FIG. 14, a high-level illustration of an exemplary computing device 1400 that can be used in accordance with the systems and methodologies disclosed herein is illustrated. For instance, the computing device 1400 may be used in a system that constructs a feed of items, where items in the feed are arranged in groups. By way of another example, the computing device 1400 can be used in a system that generates a search engine results page, where search results shown on the search engine results page are arranged in groups. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store items, embeddings, cluster representations, etc.

The computing device 1400 additionally includes a data store 1408 that is accessible by the processor 1402 by way of the system bus 1406. The data store 1408 may include executable instructions, indices, embeddings, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

It is contemplated that the external devices that communicate with the computing device 1400 via the input interface 1410 and the output interface 1412 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1400 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1400 may be a distributed system. Thus, for instance, several devices may be in communication by way of a network connection and may collectively perform tasks described as being performed by the computing device 1400.

Several aspects have been described herein in accordance with at least the following examples.

(A1) In an aspect, a method for causing clusters of electronic content items to be presented in a scrollable feed is described. The method includes receiving a request from a client computing device that is in network communication with the computing system, the request being for the scrollable feed. The method also includes identifying electronic content items from a computer-readable index based upon the request, where the electronic content items are identified as being relevant to interests of a user of the client computing device. The method further includes ranking the identified electronic content items based upon values of attributes that correspond to the identified electronic content items. The method additionally includes selecting a set of the identified electronic content items from the identified electronic content items based upon the ranking of the identified electronic content items. The method also includes assigning the selected electronic content items to clusters, where a first subset of the selected electronic content items is assigned to a first cluster and a second subset of the selected electronic content items is assigned to a second cluster. The method further includes causing the first subset of the selected electronic content items and the second subset of the selected electronic content items to be presented in the scrollable feed based upon the assigning of the selected electronic content items to the clusters.

(A2) In some embodiments of the method of (A1), causing the first subset of the selected electronic content items and the second subset of the selected electronic content items to be presented in the feed based upon the assigning of the selected electronic content items to the clusters includes: a) causing each electronic content item in the first subset of selected electronic content items to be displayed adjacent to at least one other electronic content item in the first subset of selected electronic content items; and b) causing each electronic content item in the second subset of selected electronic content items to be displayed adjacent to at least one other electronic content item in the second subset of selected electronic content items.

(A3) In some embodiments of the method of at least one of (A1)-(A2), the method also includes receiving an indication that the user has scrolled the scrollable feed. The method further includes identifying second electronic content items from the computer-readable index in response to receiving the indication, where the second electronic content items are identified as being relevant to the interests of the user of the client computing device, and further the second electronic content items do not include any of the electronic content items. The method additionally includes ranking the identified second electronic content items based upon second values of attributes that correspond to the identified second electronic content items. The method also includes selecting the threshold number of most highly ranked second electronic content items from the identified second electronic content items. The method further includes assigning the second selected electronic content items to second clusters, where a third subset of the second selected electronic content items is assigned to a third cluster and a fourth subset of the second selected electronic content items is assigned to a fourth cluster. The method additionally includes causing the third subset of the second selected electronic content items and the fourth subset of the selected electronic content items to be presented in the scrollable feed based upon the assigning of the second selected electronic content items to the second clusters.

(A4) In some embodiments of the method of at least one of (A1)-(A3), the method also includes ranking the first cluster relative to the second cluster based upon first values of attributes assigned to the first cluster and second values of the attributes assigned to the second cluster, where the first subset of the selected electronic content items is caused to be displayed relative to the second subset of the selected electronic content items based upon the ranking of the first cluster relative to the second cluster.

(A5) In some embodiments of the method of (A4), the first subset of the selected electronic content items includes a first electronic content item and a second electronic content item, and further where first item attribute values are assigned to the first electronic content item and second item attribute values are assigned to the second electronic content item. The method also includes ranking the first electronic content item relative to the second electronic content item based upon the first item attribute values and the second item attribute values, where the first subset of the selected electronic content items is caused to be displayed in the scrollable feed based upon the ranking of the first electronic content item relative to the second electronic content item.

(A6) In some embodiments of the method of at least one of (A1)-(A5), the method also includes receiving a selection of the first subset of electronic content items. The method further includes causing a third subset of the electronic content items to be displayed based upon the selection of the first subset of the electronic content items, where each content item in the third subset of the electronic content items is assigned to the first cluster, each content item in the third subset of the electronic content items is assigned to a respective subcluster of the first cluster, and further where the third subset of the electronic content items is caused to be displayed based upon the subcluster to which the respective electronic content items are assigned

(A7) In some embodiments of the method of (A6), the method also includes modifying an attribute value assigned to the first cluster based upon the first subset of electronic content items being selected, where the first cluster is subsequently ranked relative to other clusters based upon the modified attribute value assigned to the first cluster.

(A8) In some embodiments of the method of at least one of (A1)-(A7), the method also includes receiving an indication that the user has scrolled past the first subset of electronic content items in the scrollable feed without interacting with the first subset of the electronic content items. The method further includes modifying an attribute value assigned to the first cluster based upon the indication that the user has scrolled past the first subset of electronic content items in the scrollable feed, where the first cluster is subsequently ranked relative to other clusters based upon the modified attribute value assigned to the first cluster.

(A9) In some embodiments of the method of at least one of (A1)-(A8), the first subset of electronic content items consists of a first number of electronic content items, the second subset of electronic content items consists of a second number of electronic content items, and further where the first number of electronic content items is different from the second number of electronic content items.

(A10) In some embodiments of the method of at least one of (A1)-(A9), the identified electronic content items comprise computer-readable images.

(A11) In some embodiments of the method of at least one of (A1)-(A10), the first cluster is assigned a first title and the second cluster is assigned a second title. The method also includes causing the first subset of electronic content items to be displayed with the first title and causing the second subset of electronic content items to be displayed with the second title.

(A12) In some embodiments of the method of at least one of (A1)-(A11), the method also includes assigning a first background color to the first subset of electronic content items and assigning a second background color to the second subset of electronic content items, where the first background color is different from the second background color. Causing the first subset of the selected electronic content items and the second subset of the selected electronic content items to be presented in the scrollable feed based upon the assigning of the selected electronic content items to the clusters includes: a) causing the first subset of electronic content items to be displayed over a first background of the first background color; and b) causing the second subset of electronic content items to be displayed over a second background of the second background color.

(A13) In some embodiments of the method of at least one of (A1)-(A12), the electronic content items are images, and an aspect ratio of each of the electronic content items is preserved in the scrollable feed.

(A14) In some embodiments of the method of at least one of (A1)-(A13), the first subset of electronic content items includes a first electronic content item and a second content item, and where causing the first subset of the selected electronic content items and the second subset of the selected electronic content items to be presented in the scrollable feed based upon the assigning of the selected electronic content items to the clusters includes causing the first electronic content item to be displayed larger than the second electronic content item based upon a ranking of the first electronic content item relative to the second electronic content item.

(A15) In some embodiments of the method of at least one of (A1)-(A14), the method also includes generating the clusters prior to receiving a request from the client computing device, where each of the clusters includes at least one electronic content item. The method further includes constructing representations of the clusters based upon embeddings of the electronic content items within the clusters, where: a) the first subset of electronic content items is assigned to the first cluster based upon a first constructed representation of the first cluster; and b) the second subset of electronic content items assigned to the second cluster based upon a second constructed representation of the second cluster.

(A16) In some embodiments of the method of at least one of (A1)-(A15), the first subset of electronic content items includes a first electronic content item and a second electronic content item, and further where causing the first subset of the selected electronic content items and the second subset of the selected electronic content items to be presented in the scrollable feed based upon the assigning of the selected electronic content items to the clusters includes displaying the first electronic content item as partially overlaying the second electronic content item.

(B1) In another aspect, a method performed by a server computing system that is in network communication with a client computing device operated by a user is disclosed herein. The method includes receiving, from the client computing device, a request for a scrollable feed of electronic content items. The method additionally includes identifying, from a computer-readable index, electronic content items for potential inclusion in the scrollable feed in response to receiving the request for the scrollable feed of electronic content items, where the electronic content items are identified based upon content of a user profile of the user The method also includes ranking the identified electronic content items and selecting a threshold number of most highly ranked electronic content items from amongst the ranked electronic content items. The method further includes assigning the selected electronic content items to clusters of electronic content items based upon values of attributes of the selected electronic content items. The method additionally includes causing the selected electronic content items to be displayed in the scrollable feed of electronic content items based upon the assigning of the selected electronic content items to the clusters of electronic content items.

(B2) In some embodiments of the method of (B1), the method also includes generating the clusters prior to receiving the request for the scrollable feed of electronic content items, where the clusters are generated based upon interactions of the user with a set of electronic content items indexed in the computer-readable index.

(B3) In some embodiments of the method of at least one of (B1)-(B2), the method also includes ranking the clusters of electronic content items based upon values of attributes assigned to the clusters, where the scrollable feed of electronic content items is caused to be displayed based upon the ranking of the clusters.

(C1) In yet another aspect, a computing system is disclosed herein, where the computing system includes a processor and memory, where the memory stores instructions that, when executed by the processor, cause the processor to perform at least one of the methods disclosed herein (e.g., any of the methods of (A1)-(A16) and/or (B1)-(B3).

(D1) In still yet another aspect, a computer-readable storage medium is described herein, where the computer-readable storage medium includes instructions that, when executed by the processor, cause the processor to perform at least one of the methods disclosed herein (e.g., any of the methods of (A1)-(A16) and/or (B1)-(B3)).

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system that is configured to cause clusters of electronic content items to be presented in a scrollable feed, the computing system comprising:
a processor; and
memory storing instructions that, when executed by a processor, cause the processor to perform acts comprising:
receiving a request from a client computing device that is in network communication with the computing system, the request being for the scrollable feed;
based upon the request, identifying electronic content items from a computer-readable index, where the electronic content items are identified as being relevant to interests of a user of the client computing device;
ranking the identified electronic content items based upon values of attributes that correspond to the identified electronic content items;
selecting a set of the identified electronic content items from the identified electronic content items based upon the ranking of the identified electronic content items;
assigning the selected electronic content items to clusters, where a first subset of the selected electronic content items is assigned to a first cluster and a second subset of the selected electronic content items is assigned to a second cluster; and
causing the first subset of the selected electronic content items and the second subset of the selected electronic content items to be presented in the scrollable feed based upon the assigning of the selected electronic content items to the clusters.

2. The computing system of claim 1, where causing the first subset of the selected electronic content items and the second subset of the selected electronic content items to be presented in the feed based upon the assigning of the selected electronic content items to the clusters comprises:
causing each electronic content item in the first subset of selected electronic content items to be displayed adjacent to at least one other electronic content item in the first subset of selected electronic content items; and
causing each electronic content item in the second subset of selected electronic content items to be displayed adjacent to at least one other electronic content item in the second subset of selected electronic content items.

3. The computing system of claim 1, the acts further comprising:
receiving an indication that the user has scrolled the scrollable feed;
responsive to receiving the indication, identifying second electronic content items from the computer-readable index, where the second electronic content items are identified as being relevant to the interests of the user of the client computing device, and further the second electronic content items do not include any of the electronic content items;
ranking the identified second electronic content items based upon second values of attributes that correspond to the identified second electronic content items;
selecting the threshold number of most highly ranked second electronic content items from the identified second electronic content items;
assigning the second selected electronic content items to second clusters, where a third subset of the second selected electronic content items is assigned to a third cluster and a fourth subset of the second selected electronic content items is assigned to a fourth cluster; and
causing the third subset of the second selected electronic content items and the fourth subset of the selected electronic content items to be presented in the scrollable feed based upon the assigning of the second selected electronic content items to the second clusters.

4. The computing system of claim 1, the acts further comprising:
ranking the first cluster relative to the second cluster based upon first values of attributes assigned to the first cluster and second values of the attributes assigned to the second cluster, where the first subset of the selected electronic content items is caused to be displayed relative to the second subset of the selected electronic content items based upon the ranking of the first cluster relative to the second cluster.

5. The computing system of claim 4, where the first subset of the selected electronic content items comprises a first electronic content item and a second electronic content item, and further where first item attribute values are assigned to the first electronic content item and second item attribute values are assigned to the second electronic content item, the acts further comprising:
ranking the first electronic content item relative to the second electronic content item based upon the first item attribute values and the second item attribute values, where the first subset of the selected electronic content items is caused to be displayed in the scrollable feed based upon the ranking of the first electronic content item relative to the second electronic content item.

6. The computing system of claim 1, the acts further comprising:
receiving a selection of the first subset of electronic content items;
based upon the selection of the first subset of the electronic content items, causing a third subset of the electronic content items to be displayed, where each content item in the third subset of the electronic content items is assigned to the first cluster, each content item in the third subset of the electronic content items is assigned to a respective subcluster of the first cluster, and further where the third subset of the electronic content items is caused to be displayed based upon the subcluster to which the respective electronic content items are assigned.

7. The computing system of claim 6, the acts further comprising:
modifying an attribute value assigned to the first cluster based upon the first subset of electronic content items being selected, where the first cluster is subsequently ranked relative to other clusters based upon the modified attribute value assigned to the first cluster.

8. The computing system of claim 1, the acts further comprising:
receiving an indication that the user has scrolled past the first subset of electronic content items in the scrollable feed without interacting with the first subset of the electronic content items; and
modifying an attribute value assigned to the first cluster based upon the indication that the user has scrolled past the first subset of electronic content items in the scrollable feed, where the first cluster is subsequently ranked relative to other clusters based upon the modified attribute value assigned to the first cluster.

9. The computing system of claim 1, where the first subset of electronic content items consists of a first number of electronic content items, the second subset of electronic content items consists of a second number of electronic content items, and further where the first number of electronic content items is different from the second number of electronic content items.

10. The computing system of claim 1, where the identified electronic content items comprise computer-readable images.

11. The computing system of claim 1, where the first cluster is assigned a first title and the second cluster is assigned a second title, the acts further comprising:
causing the first subset of electronic content items to be displayed with the first title; and
causing the second subset of electronic content items to be displayed with the second title.

12. The computing system of claim 1, the acts further comprising:
assigning a first background color to the first subset of electronic content items; and
assigning a second background color to the second subset of electronic content items, where the first background color is different from the second background color;
where causing the first subset of the selected electronic content items and the second subset of the selected electronic content items to be presented in the scrollable feed based upon the assigning of the selected electronic content items to the clusters comprises:
causing the first subset of electronic content items to be displayed over a first background of the first background color; and
causing the second subset of electronic content items to be displayed over a second background of the second background color.

13. The computing system of claim 1, where the electronic content items are images, and further where an aspect ratio of each of the electronic content items is preserved in the scrollable feed.

14. The computing system of claim 1, where the first subset of electronic content items includes a first electronic content item and a second content item, and further where causing the first subset of the selected electronic content items and the second subset of the selected electronic content items to be presented in the scrollable feed based upon the assigning of the selected electronic content items to the clusters comprises:
causing the first electronic content item to be displayed larger than the second electronic content item based upon a ranking of the first electronic content item relative to the second electronic content item.

15. The computing system of claim 1, the acts further comprising:
prior to receiving a request from the client computing device, generating the clusters, where each of the clusters includes at least one electronic content item; and
constructing representations of the clusters based upon embeddings of the electronic content items within the clusters, where:
the first subset of electronic content items is assigned to the first cluster based upon a first constructed representation of the first cluster; and
the second subset of electronic content items assigned to the second cluster based upon a second constructed representation of the second cluster.

16. The computing system of claim 1, where the first subset of electronic content items comprises a first electronic content item and a second electronic content item, and further where causing the first subset of the selected electronic content items and the second subset of the selected electronic content items to be presented in the scrollable feed based upon the assigning of the selected electronic content items to the clusters comprises displaying the first electronic content item as partially overlaying the second electronic content item.

17. A method performed by a server computing system that is in network communication with a client computing device operated by a user, the method comprising:
receiving, from the client computing device, a request for a scrollable feed of electronic content items;
in response to receiving the request for the scrollable feed of electronic content items, identifying, from a computer-readable index, electronic content items for potential inclusion in the scrollable feed, where the electronic content items are identified based upon content of a user profile of the user;
ranking the identified electronic content items;
selecting a threshold number of most highly ranked electronic content items from amongst the ranked electronic content items;
assigning the selected electronic content items to clusters of electronic content items based upon values of attributes of the selected electronic content items; and
causing the selected electronic content items to be displayed in the scrollable feed of electronic content items based upon the assigning of the selected electronic content items to the clusters of electronic content items.

18. The method of claim 17, further comprising:
prior to receiving the request for the scrollable feed of electronic content items, generating the clusters, where the clusters are generated based upon interactions of the user with a set of electronic content items indexed in the computer-readable index.

19. The method of claim 17, further comprising:
ranking the clusters of electronic content items based upon values of attributes assigned to the clusters, where the scrollable feed of electronic content items is caused to be displayed based upon the ranking of the clusters.

20. A computer-readable storage medium comprising instructions that, when executed by a processor, cause the processor to perform acts comprising:
receiving a request from a client computing device that is in network communication with the computing system, the request being for the scrollable feed of electronic content items;
based upon the request, identifying electronic content items from a computer-readable index, where the electronic content items are identified as being relevant to interests of a user of the client computing device;
ranking the identified electronic content items based upon values of attributes that correspond to the identified electronic content items;
selecting a threshold number of most highly ranked electronic content items from the identified electronic content items;
assigning the selected electronic content items to clusters, where a first subset of the selected electronic content items is assigned to a first cluster and a second subset of the selected electronic content items is assigned to a second cluster; and
causing the first subset of the selected electronic content items and the second subset of the selected electronic content items to be presented in the scrollable feed of content items based upon the assigning of the selected electronic content items to the clusters.
